(19) United States
(12) Patent Application Publication
(10) Pub. No.: US 2013/0044466 A1
(43) Pub. Date: Feb. 21, 2013

(54) PORTABLE COLLAPSIBLE GREEN SCREEN

(71) Applicant: Rockwell L. Scharer, III, Los Angeles, CA (US)

(72) Inventor: Rockwell L. Scharer, III, Los Angeles, CA (US)

(21) Appl. No.: 13/284,843

(22) Filed: Oct. 28, 2011

Related U.S. Application Data
(60) Provisional application No. 61/523,781, filed on Aug. 15, 2011.

(51) Int. Cl. H04N 5/28; A63J 5/00; F21L 4/00

(52) U.S. Cl. 362/157; 428/12

(57) ABSTRACT

A portable and collapsible, green screen device for videographers and photographers. The green screen has manually assembled and disassembled frame members on which are placed colored panels or colored fabric. The frame members may be bendable tubes, and press-fit together. The panels cover all frame members with a selected keying color. The screen defines a three-dimensional cavity having a rear zone, right and left zones, floor, and ceiling of the space enclosed by the colored panels or fabric. Lighting modules and microphones may be rendered in the keying color and may be mounted on the frame. Lighting modules may incorporate a speaker in addition to illumination elements, and may contain or anchor speakers which may be rendered in the keying color.

### REFERENCE TO RELATED APPLICATION

This application is related to Ser. No. 13/103,821, filed May 9, 2011, and to Ser. No. 61/523,781, filed Aug. 15, 2011.

### FIELD OF THE INVENTION

The present invention relates to digital image formation, and more particularly to a “green screen” or color mask for chroma keying or background replacement of a site-for-image recording.

### BACKGROUND OF THE INVENTION

Contemporary digitized video production is frequently enhanced by recording a person superimposed over a false background. The background may be a simulated background which visually suggests that the recording has been made at a location which is remote from the site of the actual recording. An example is seen in news broadcasts which for verisimilitude show backgrounds of the scene of news events, with audio and video recording of a news announcer being superimposed over the simulated background.

For best fidelity, the simulated background may be based on an actual recording of the site of the news event. The recording is digitized and is superimposed onto the background at the site of the actual audio and video recording of the news announcer.

The process of superimposing recorded visual content over the background is feasibly conducted by a computerized method wherein background of a predetermined color, and only background of the predetermined color, is replaced by the visual content. In the computerized method, pixels of the predetermined color are replaced by pixels from the recorded visual content. The result is a fairly realistic rendering which makes it appear to the broadcast audience that the news announcer is actually being filmed or recorded at the site of the background visual content.

In practice, recording takes place in a studio equipped with masking equipment which is adapted to present a monochromatic background, usually of a color which contrasts strongly with natural skin colors, to facilitate appropriate pixel substitution. Blue and green have become the colors of choice for such background masking. The equipment which covers the actual background with selected coloring will be referred to herein as “green screen”.

It is an easy matter to have a professional studio equipped for green screen backgrounds. However, there are a number of situations, many not related to news broadcasts, where it is desired to have a green screen at a location which is not at a professional studio. There arises a need then to have a green screen which is readily brought to an intended recording site and expeditiously erected at that site.

### SUMMARY OF THE INVENTION

The present invention addresses the above stated need by providing a green screen which is collapsible or knock-down, light-weight, and portable. The novel green screen may be carried about in compact, lightweight form, and expeditiously manually assembled and disassembled.

When erected, the green screen has a self-supporting frame to which are coupled plural panels rendered in a selected green screen color, such as green or blue. The green screen includes cushioned bases, elongated skeleton members for defining a three dimensional frame, color panels which are coupled to the frame, and self-contained lamps for illuminating a person standing inside the open space of the frame. Color panels cover the background, right and left sides, the top, and the bottom, thereby establishing up to a five-sided envelope which is color treated to enable pixel substitution as described above. The self-contained lamps and microphones may bear coverings rendered in a green screen color, so that close illumination is provided which will not interfere with pixel substitution.

It is an object of the invention to provide a portable green screen.

Another object of the invention is to cover not only the background, but potentially also right and left sides, top, and bottom of that space occupied by a person being imaged.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of a portable green screen according to at least one aspect of the invention.

FIG. 2 is an exploded perspective view of frame members used in green screen of FIG. 1.

FIG. 3 is a perspective detail view of a stub connector which is an alternative to a connection scheme shown in FIG. 2.

FIG. 4 is a perspective detail view of another stub connector which is an alternative to the connection scheme shown in FIG. 2.

FIG. 5 is a perspective detail view of three frame members two of which are visible in FIG. 1.

FIG. 6 is an exploded perspective detail view of flexible color panels which are used with the green screen of FIG. 1, wherein the color panels are shown isolated from other components of their associated green screen.

FIG. 7 is a perspective detail view of a flexible color panel which is usable with the green screen of FIG. 1.

FIG. 8 is a perspective detail view of another flexible color panel which is an alternative to the flexible color panel of FIG. 7.

FIG. 9 is a top plan view of a component seen at the front of FIG. 1.

FIG. 10 is a perspective diagrammatic view of an arrangement of frame members different from the arrangement of the frame of FIG. 1.

FIG. 11 is an exploded perspective detail view of another arrangement of color panels usable with a green screen according to at least one aspect of the invention, wherein the color panels are shown isolated from other components of their associated green screen.

### DETAILED DESCRIPTION

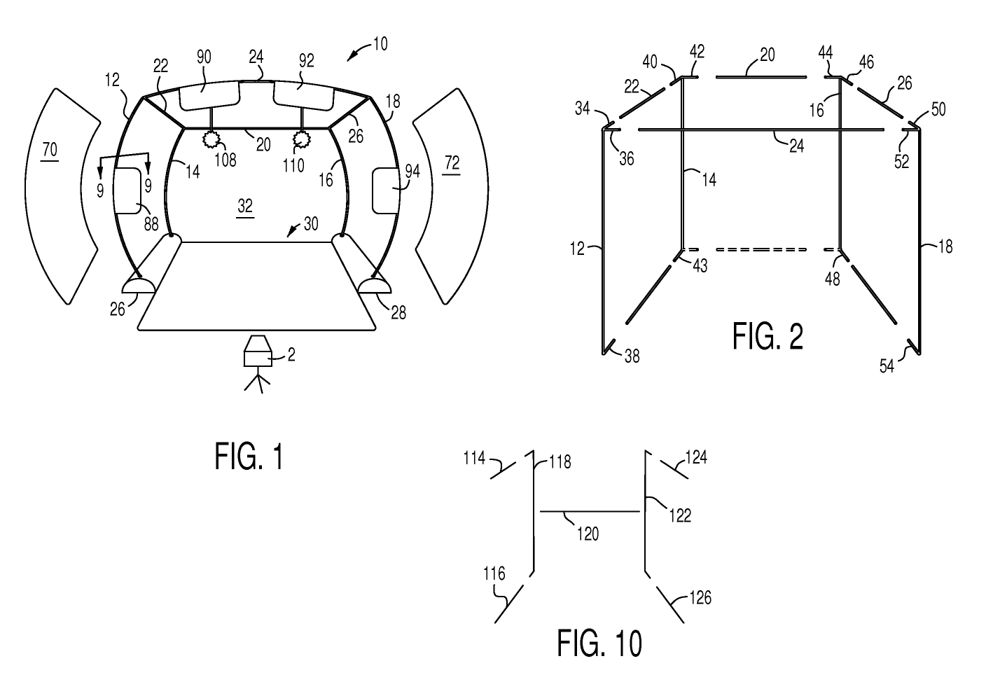

FIG. 1 shows a portable green screen 10 for providing a monochromatic color background for video recording, to enable subsequent pixel substitution such as by chroma key compositing. The green screen 10 may be used with the video production procedures which are set forth in Ser. No. 13/103,821, filed May 9, 2011, and in Ser. No. 61/523,781, filed Aug. 15, 2011, which are hereby explicitly incorporated by reference as though each were fully set forth.

The green screen 10 comprises an open skeleton frame which comprises a plurality of manually joined and separated bendable tubular press fit linear members 12, 14, 16, 18, 20, 22, 24 and three base members 26, 28, 30. The press fit linear members may be assembled to define a three dimensional enclosed space having a rear zone, a right side zone, a left side zone, a floor zone, a ceiling zone, and an open front end. The three base members 26, 28, 30 are disposed to lie on a floor surface, with each base member 26, 28, or 30 may be arranged at right angles to adjacent base members 26, 28, 30, thereby forming three sides of a rectangle. The base member 30 is not visible in FIG. 1, being concealed behind a flexible web 32 supported on the skeleton frame at the rear zone.

It should be noted at this point that orientational terms such as left, right, front, and rear refer to the subject drawing as viewed by an observer (not shown) who could for example be located behind a video camera 2, looking into the enclosed space within the skeleton frame. The drawing figures depict their subject matter in orientations of normal use, which could obviously change with changes in position of the green screen 10 or its component parts. Therefore, orientational terms must be understood to provide semantic basis for purposes of description, and do not limit the invention or its component parts in any particular way.

In FIG. 5, the base members 26, 28, 30 are seen isolated from the press fit linear members 12, 14, 16, 18, 20, 22, 24, 26, and at right angles to one another. The base members 26, 28, 30 may comprise internal metal or polymeric tubes (not visible) covered by cushions 26A, 28A, 30A, which are colored with a keying color which is consistent with computerized pixel substitution. The base members 26, 28 may have sockets 60, 62, 64, 66 into which the vertical linear members 12, 14, 16, 18 are inserted. As an alternative to the sockets 60, 62, 64, 66, the base members 26, 28 could be provided with stub connectors such as the stub connector 58 of FIG. 4.

Continuing with description of the skeleton frame, there are four vertical linear members 12, 14, 16, 18 each anchored at one end of one of the base members 26, 28, 30, and four linear members 20, 22, 24, 26 adapted to occupy a horizontal plane when the open skeleton frame is assembled and to define a ceiling zone.

Each one of the four linear members 20, 22, 24, 26 has opposed ends each supported at one of the vertical linear members 12, 14, 16, 18.

The press fit linear members 12, 14, 16, 18, 20, 22, 24, 26 may be bendable or flexible tubes, made from metal or from a polymeric material. The press fit linear members 12, 14, 16, 18, 20, 22, 24, 26 interfit telescopically to one another, and may be manually press fit into place. A plurality of stub connectors which are dimensioned and configured to couple telescopically to the press fit linear members 12, 14, 16, 18, 20, 22, 24, 26 may be provided. Illustratively, and turning momentarily to FIG. 2, stub connectors 34, 36, 38 are formed integrally with the vertical press fit linear member 12 and project therefrom at a right angle to the longitudinal axis of the press fit linear member 12. The stub connectors 34, 36, 38 are of exterior diameter slightly less than the interior diameters of the press fit linear members 22 and 24. Other stub connectors 40, 42, 44, 46, 48, 50, 52, 54 may be similar in structure and function to the stub connectors 34, 36, 38.

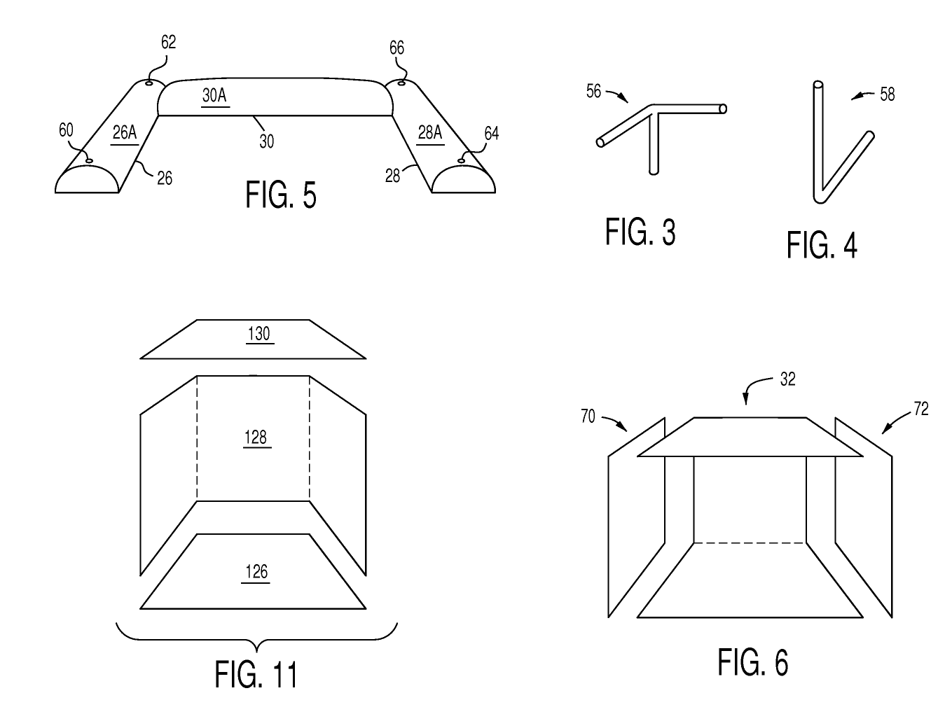

Referring to FIGS. 3 and 4, it would be possible to form stub connectors separately from their associated press fit linear members 12, 14, 16, 18, 20, 22, 24, 26. For example, a green screen according to the present invention may utilize three-branch stub connectors such as the stub connector 56 and two-branch stub connectors such as the stub connector 58.

The skeleton frame supports a plurality of flexible webs or socks 32, 70, 72 all of which are colored in a keying color to permit pixel substitution. Exemplary keying colors include strong, bright pure green and strong, bright pure blue, where these colors are essentially similar to the blue and green colors which would be seen when dividing rays of natural sunlight by a prism and projecting the divided rays onto a white screen, for example. These colors contrast strongly with natural skin colors, thereby minimizing the possibility that the pixel substitution process will mistakenly delete part of the skin of the announcer and substitute background pixels therefor. Also, these strong colors are unique and distinctive, and the webs are readily recognizable as special purpose and members of a related set of webs, and are unlikely to be mistaken for other devices such as tents.

The webs 32, 70, 72 have edges which are carefully mounted so as to fully cover the skeleton frame from frontal view, such as that originating at the video camera 2 and facing the open front end of the green screen 10, to assure appropriate color covering and successful pixel substitution. All of the webs 32, 70, 72 are similarly colored in the keying color. The webs 32, 70, 72 comprise mounting apparatus for engaging the open skeleton frame such that the open skeleton frame is fully covered and is entirely concealed from frontal view. The mounting apparatus is provided wherever one of the flexible webs 32, 70, 72 contacts a press fit linear member 12, 14, 16, 18, 20, 22, 24, 26 of the open frame skeleton along one edge of the flexible web 32, 70, or 72.

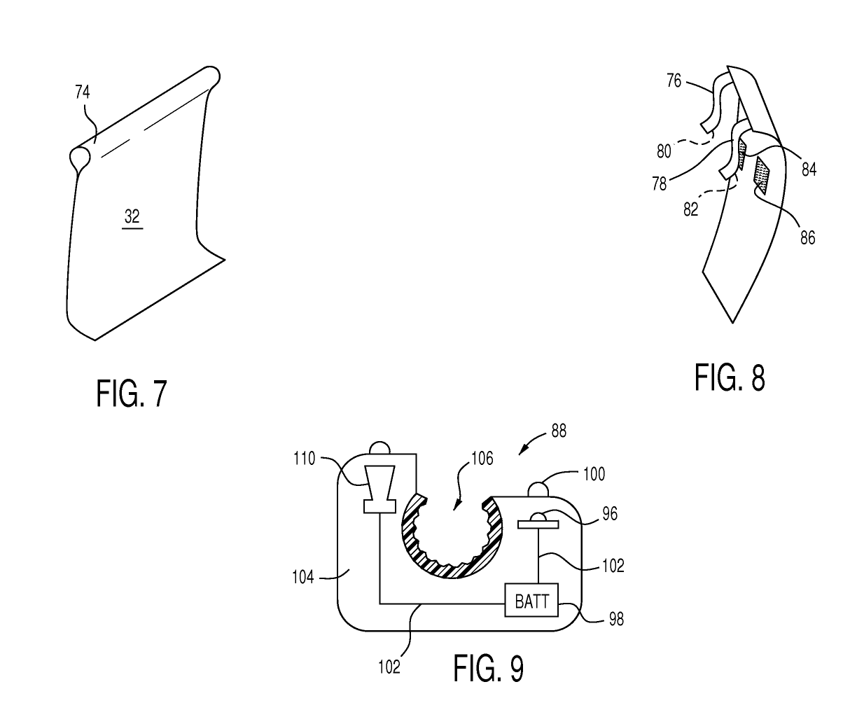

FIG. 7 shows one form of mounting apparatus for retaining the web 32 to a linear member 12, 14, 16, 18, 20, 22, 24, or 26. The web may have a closed hem 74 extending along its edge to receive insertion of the linear member 12, 14, 16, 18, 20, 22, 24, or 26. Of course, the webs 70 and 72 may be similar.

FIG. 8 shows another form of mounting apparatus for retaining the web 70 to a linear member 12, 14, 16, 18, 20, 22, 24, or 26. The web 70 may have several strips 76, 78 each bearing respective patches 80, 82 of hook and loop fastener. The strips 76, 78 may mate with corresponding patches 84, 86 of hook and loop fastener affixed to the main panel of the web 70.

As seen in FIG. 1, a lighting module 88, may be coupled to the skeleton frame of the green screen 10. Referring to FIG. 9, the lighting module 88 may comprise an illumination source such as an LED 96, a battery 98 connected to the LED 96, and a switch (represented by a switch operator such as a pushbutton 100). Although not shown, circuitry 102 will be understood to extend to the switch such that the switch can be used to turn the LED 96 on and off.

The lighting module 88 may include a housing 104 which on its exterior is colored in the keying color, and at least one grip 106 for engaging one of the press fit linear members 12, 14, 16, 18, 20, 22, 24, 26 of the open skeleton frame. The grip 106 may comprise for example a rubber partial sleeve adapted to close over and grasp the tube of one of the press fit linear members 12, 14, 16, 18, 20, 22, 24, 26. The grip 106 may have grip characteristics enabling the grip 106 to be manually placed on and removed from its associated press fit linear member 12, 14, 16, 18, 20, 22, 24, or 26. The lighting module 88 is one of a plurality of similar separate lighting modules 90, 92, 94 which may be utilized with the green screen 10.

Again referring to FIG. 1, the lighting module 88 may comprise a microphone 108 which is colored in the keying color, and has an attachment element for removably attaching or otherwise coupling to the press fit linear member 12 of the open skeleton frame. The attachment element may take any suitable form, ranging from a clip, a patch of hook and loop material, a hook, and similar fasteners (none shown) to being incorporated integrally into the lighting module 88.

Returning to FIG. 9, the lighting module 88 may comprise a speaker 110 which may have an attachment element for removably attaching or coupling to the press fit linear member 12 of the open skeleton frame. The attachment element may comprise a fastener such as a clip, a patch of hook and loop material, a hook, and similar fasteners (none shown) or may be incorporated integrally into the lighting module 88, as depicted. The speaker 110 may be connected to the battery 98 by circuitry 102, which will be understood to extend to a switch (represented by a switch operator 112) so that the speaker 110 may be turned on and off. It is also contemplated by the inventor that the lighting modules, speakers, microphones, and other related electronics described herein may be AC power-operated.

The green screen 10 has been described in terms of press fit linear members comprising three base members 26, 28, 30, four vertical linear members 12, 14, 16, 18, and four linear members 20, 22, 24, 26 adapted to occupy a horizontal plane when the open skeleton frame is assembled and to define a ceiling zone. However, other arrangements of the open skeleton frame are possible.

This is shown in FIG. 10, which diagrammatically shows a skeleton frame made from fewer than the number of constituent members of the skeleton frame of FIGS. 1 and 2. The skeleton frame of FIG. 10 includes seven principal members 114, 116, 118, 120, 122, 124, 126, which may be generally similar in construction and connection to their counterparts of FIGS. 1 and 2, differing only in number and connection to adjacent members.

Therefore, an open skeleton frame for a portable green screen according to the present invention may comprise a plurality of manually joined and separated press fit linear members such as the press fit linear members 12, 14, 16, 18, 20, 22, 24, and 26, which may be assembled to define a three dimensional enclosed space. The enclosed space may include a rear zone, a right side zone, a left side zone, a floor zone, a ceiling zone, and may define an open front end. The number of press fit linear members may include at least two base members such as the base members 26, 28, disposed to lie on a floor surface, but not necessarily more than two; at least but not necessarily more than two vertical linear members, such as the vertical linear members 12, 14, 16, or 18; and at least two linear members such as the linear members 20, 22, 24, or 26, adapted to occupy a horizontal plane when the open skeleton frame is assembled and to define a ceiling zone.

The number and arrangement of flexible webs such as the flexible webs 32, 70, and 72 may be varied from the arrangement of FIG. 1. As seen in FIG. 11, the flexible webs may include a floor web 126, a wall web 128 which covers right and left side zones, and a rear zone, and a ceiling or upper web 130. The number and arrangement of flexible webs may be further varied. For example, each of the five covered sides of the interior space may have its own flexible web (not shown). The five covered sides may be covered by one large cruciform flexible web, by two flexible webs, or by four flexible webs (none of these options is shown). Also, more than one of the covered sides may be covered by a curved flexible web, rather than having flexible webs which essentially occupy planar spaces.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible

I claim:

1. A portable green screen device for providing a monochromatic color background for video recording, to enable subsequent pixel substitution, comprising:
an open skeleton frame comprising a plurality of manually joined and separated press fit linear members which may be assembled to define a three dimensional enclosed space having a rear zone, a right side zone, a left side zone, a floor zone, a ceiling zone, and an open front end, comprising at least two base members disposed to lie on a floor surface, at least two vertical linear members, and at least two linear members adapted to occupy a horizontal plane when the open skeleton frame is assembled and to define a ceiling zone;
a plurality of stub connectors which are dimensioned and configured to couple telescopically to the press fit linear members; and
a plurality of flexible webs having edges, which said flexible webs are similarly colored in a keying color which is consistent with computerized pixel substitution and which comprise mounting apparatus for engaging the open skeleton frame such that the open skeleton frame is covered by the flexible webs and is entirely concealed from view from the open front end wherever one of the flexible webs contacts a said press fit linear member of the open frame skeleton along one edge of the flexible web.

2. The portable green screen device of claim 1, wherein the base members are covered by cushions, and the cushions are colored in the keying color.

3. The portable green screen device of claim 1, wherein each of the stub connectors is integral with and projects from one press fit linear member at a right angle to the longitudinal axis of the press fit linear member.

4. The portable green screen device of claim 1, wherein at least one of the press fit linear members comprises a bendable tube.

5. The portable green screen device of claim 1, further comprising at least one lighting module which comprises
an illumination source, a battery connected to the illumination source, and a switch; and
a housing colored in the keying color, and at least one grip for engaging one of the press fit linear members of the open skeleton frame.

6. The portable green screen device of claim 5, further comprising a plurality of separate lighting modules.

7. The portable green screen device of claim 1, further comprising a microphone which is colored in the keying color, and has an attachment element for removably attaching to one of the press fit linear members of the open skeleton frame.

8. The portable green screen device of claim 7, further comprising at least one lighting module which comprises an illumination source, a battery connected to the illumination source, a switch, and a housing colored in the keying color, and at least one grip for engaging one of the press fit linear members of the open skeleton frame, wherein the microphone is coupled to the lighting module.

9. The portable green screen device of claim 1, further comprising a speaker which is colored in the keying color, and has an attachment element for removably attaching to one of the press fit linear members of the open skeleton frame.

10. The portable green screen device of claim 9, further comprising at least one lighting module which comprises an illumination source, a battery connected to the illumination source, a switch, and a housing colored in the keying color, and at least one grip for engaging one of the press fit linear members of the open skeleton frame, wherein the speaker is coupled to the lighting module.

11. The portable green screen device of claim 1, wherein the keying color is one of strong, bright pure green and strong, bright pure blue.

12. A portable green screen device for providing a monochromatic color background for video recording, to enable subsequent pixel substitution, comprising:
an open skeleton frame comprising a plurality of manually joined and separated bendable tubular press fit linear members which may be assembled to define a three dimensional enclosed space having a rear zone, a right side zone, a left side zone, a floor zone, a ceiling zone, and an open front end, the press fit linear members comprising three base members disposed to lie on a floor surface and arranged at right angles to adjacent said base members, thereby forming three sides of a rectangle, four vertical linear members each anchored at one end of one of the base members, and four linear members adapted to occupy a horizontal plane when the open skeleton frame is assembled and to define a ceiling zone, wherein each one of the four linear members has opposed ends each supported at one of the vertical linear members;
a plurality of stub connectors which are dimensioned and configured to couple telescopically to the press fit linear members; and
a plurality of flexible webs having edges, which said flexible webs are similarly colored in a keying color which is consistent with computerized pixel substitution and which comprise mounting apparatus for engaging the open skeleton frame such that the open skeleton frame is covered by the flexible webs and is entirely concealed from view from the open front end wherever one of the flexible webs contacts a said press fit linear member of the open frame skeleton along one edge of the flexible web.
